(19) United States
(12) Patent Application Publication
(10) Pub. No.: US 2018/0129758 A1
(43) Pub. Date: May 10, 2018

(54) METHOD FOR IMPROVING RUNTIME PERFORMANCE OF MULTI-CLOCK DESIGNS ON FGPA AND EMULATION SYSTEMS USING ITERATIVE PIPELINING

(71) Applicant: PRATEEK SIKKA, New Delhi (IN)

(72) Inventor: PRATEEK SIKKA, New Delhi (IN)

(21) Appl. No.: 15/414,129

(22) Filed: Jan. 24, 2017

(30) Foreign Application Priority Data
Nov. 8, 2016 (IN) 201611038193

(51) Int. Cl. G06F 17/50

(52) U.S. Cl. CPC G06F 17/505; G06F 17/5027; G06F 17/5081; G06F 17/5054

(57) ABSTRACT

The present invention relates to a method to improve the runtime performance of designs with multiple clocks on FPGA's and emulation system. In the method, the compile frequency (F_{Max}) for complex design is improved by breaking-up the critical timing path of the design by inserting pipeline flops iteratively which are clocked at faster available clock frequencies. The method is easily implemented in a design where the clocks are of different frequencies but derived from the same primary clock i.e. the clocks are synchronous to each other and ratio of highest to lowest clock frequencies is more than or equal to 2. It enables optimal usage of emulator up time and hardware area.

### TECHNICAL FIELD

The present invention relates to the field of verification of multi-clock Integrated Circuit designs, more particularly, to a method for improving the runtime performance of multi-clock digital designs on FPGA and Emulation systems using iterative pipelining.

### BACKGROUND OF THE INVENTION

In past few decades, SoC designs are becoming increasingly complex which brings together various blocks or subsystems, and often each of it has its own clock requirement. A complex design has multiple subsystems or blocks which require verification independently and also as a complete system to ensure the system works well on the whole.

Emulation and FPGA prototyping play a very crucial role in the design flow. Emulation is the process of imitating the behavior of one or more components of hardware with another component of hardware. The software tool chain analyses, synthesizes and optimizes the hardware description language (HDL) designs in the form of gates to create the emulation database. Further, the emulation database is used to emulate a design and then verify its functionality at a much faster pace than the conventional PC based simulators.

However, multi clock digital designs are complex designs and it is very difficult to compile these designs by the compilers. In other words, due to increasing complexity of the designs, it becomes very difficult for compilers to handle complex clock trees in the designs. Specifically, if the compile frequencies in a multiple clock design are not related to each other or in other words if the multiple clocks are not of same frequencies, the compile frequency for the FPGA or emulation system is low, thereby affecting the runtime performance.

Therefore, there is need for a method to overcome the aforesaid problems. The present invention provides a method for improving performance of multi-clock designs on FPGA and Emulation system using iterative pipelining during the verification phase. The present method improves the compile frequency of the design having multiple clocks and wherein the ratio of fastest to slowest clock is more than “2”.

### SUMMARY OF THE INVENTION

The object of the present invention is to provide a method to improve the runtime performance of designs with multiple clocks on FPGA's and emulation systems.

Another object of the present invention is to provide a method to improve the compile frequency (F_{Max}) for complex design by breaking-up the critical timing path of the designs using flops which are clocked at faster available clock frequencies.

Another object of the present invention is to apply the method of inserting flop in the critical path iteratively in the design in order to improve compile time synthesis frequency of the design.

Another object of the invention is to improve compile frequency of a design having multiple clocks in the scenario where the ratio of highest to lowest clock frequencies is more than or equal to 2.

A further object of the invention is to improve compile frequency of a design where the clocks are of different frequencies but derived from the same primary clock i.e. the clocks are synchronous to each other.

Yet another object of the invention is optimal usage of emulator up time and hardware area by ensuring the run for more tests since the runtime performance is improved.

Other objects and advantages of the present invention will become apparent from the following description taken in connection with the accompanying drawings, wherein, by way of illustration and example, the aspects of the present invention are disclosed.

### BRIEF DESCRIPTION OF THE DRAWINGS

The present invention will be better understood after reading the following detailed description of the presently preferred aspects thereof with reference to the appended drawings, in which:

FIG. 1 illustrates the typical modern SoC design wherein multiple clocks are derived from a single faster clock by the means of divider circuitry;

FIG. 2 illustrates the calculation of critical path for a clock path;

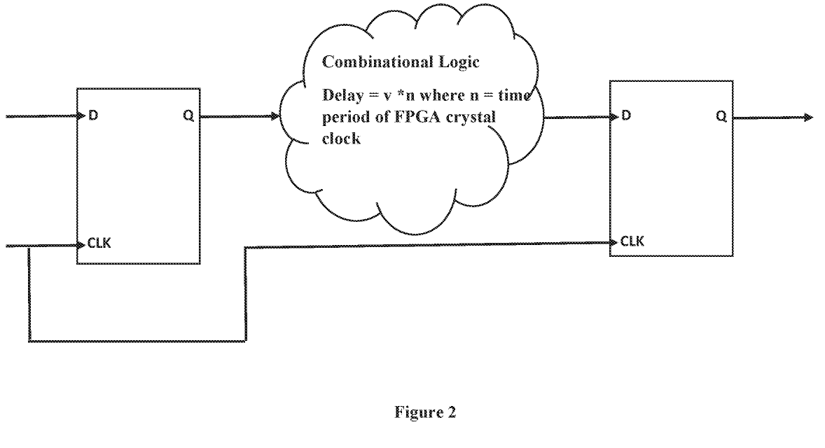

FIG. 3 illustrates breaking of the critical path by inserting a flop; and

FIG. 4 illustrates the step-by-step method of working of the present invention.

### DETAILED DESCRIPTION OF THE DRAWINGS

The present disclosure pertains to verification of Integrated Circuits. In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

The following description describes various features and functions of the disclosed method with reference to the accompanying figures. In the figures, similar symbols identify similar components, unless context dictates otherwise. The illustrative aspects described herein are not meant to be limiting. It may be readily understood that certain aspects of the disclosed method can be arranged and combined in a wide variety of different configurations, all of which are contemplated.

The mapping of a design on a hardware prototype like FPGA or Emulation system has many advantages such as, decrease the verification or testing time of the designs. When a design with complex clock tree is synthesized onto an FPGA hardware using a compiler tool chain, complex timing paths are created and hence it gets difficult for the compiler to perform a better routing. If the degree of complexity of the design increases, then the compile frequency also decreases. However, for the better runtime performance of design, the value of compile frequency (F_{Max}) should be high.

The main aspect of the invention is a method to improve the compile frequency (F_{Max}) for complex multi-clock designs. In the method, multi-clock SOC design is synthesized on FPGA/Emulation tool and compile/synthesis frequency (F-max) is obtained. The design is analyzed to obtain the maximum clock frequency corresponding to the critical path. If the clock at which the critical path is clocked, is not the fastest clock of the design, then the path is broken with a pipeline flop which is clocked at a clock which is at least 2 times faster. This reduces the combinational delay path of the design.

The method is applicable in design scenarios where the clocks are of different frequencies but derived from the same primary clock which means the clocks are synchronous to each other.

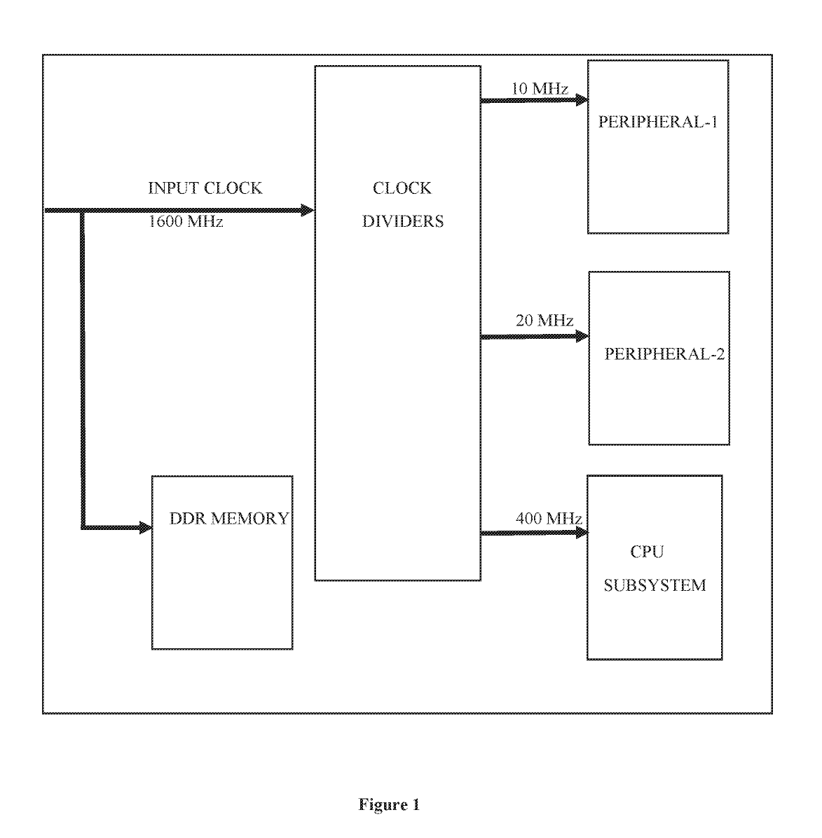

Typically, in any FPGA or emulation compiler toolchain, all the design clocks are derived from a fastest clock with the help of divider as shown in FIG. 1. For example, a design has 3 clocks 100 MHz, 50 MHz, and 10 MHz. Now, the design is analyzed and synthesized onto FPGA along with clock constraints. Specifically, clock tree synthesis is done for each of the specified clocks and timing analysis is done for each of the clock paths. In response, timing paths are reported for each of the timing or clock paths according to the amount of combinational logic between 2 flops.

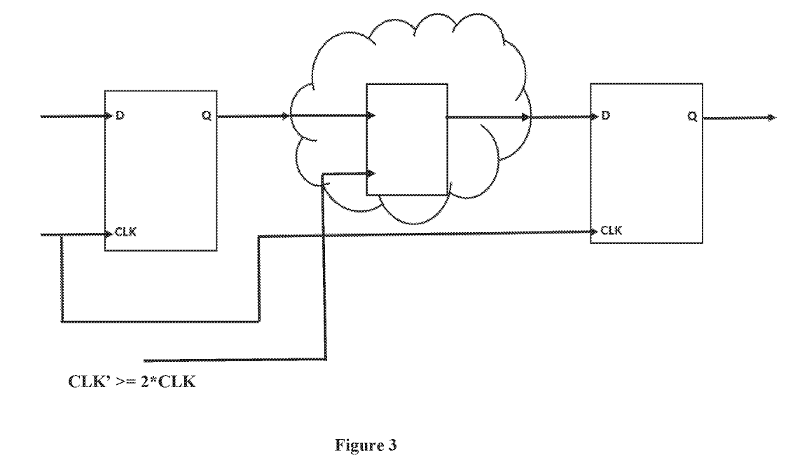

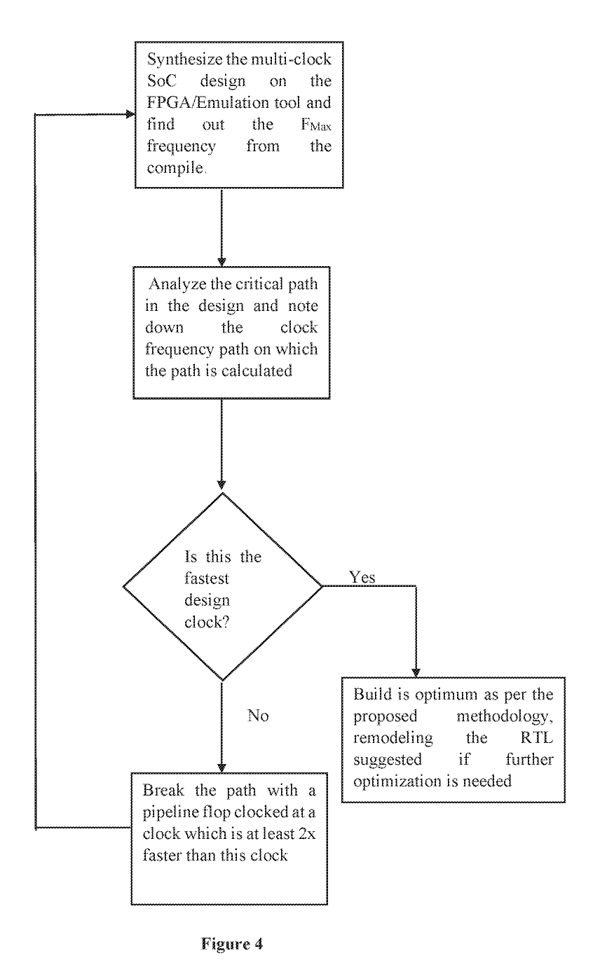

Moreover, critical path is the path between two flops where maximum combinational delay occurs. Now according to the present invention (as shown in FIG. 3), once the critical path is reported then it is broken-up by adding a pipeline flop with intent to reduce the combinational path delay. These inserted flops are clocked at faster available frequencies (minimum 2×) than the current clock frequency. The step-by-step method of working of present invention is shown in FIG. 4 to improve the compile and consequently the runtime frequency of a multi clock design. The said method is applied iteratively in the design to improve the compile time synthesis frequency.

For example, if the design has 4 clocks namely 200 MHz, 400 MHz, 800 MHz and 1600 MHz. and if the delay of the critical path is 394 nanoseconds (wherein unit of the delay is depending on the fastest FPGA hardware technology clock). For better understanding of present invention methodology, let us assume above said critical path lies on a clock path corresponding to the frequency of 200 MHz.

Further, the said delay of the critical path could be broken up into 200+194 nanosecond by inserting one D flop at a clocked rate of 400 MHz without causing any change to the functionality of the design. Also, the same path could be broken up by inserting 2 flops at a clocked rate of 800 MHz or by inserting 4 flops at a clocked rate of 1600 MHz. More clearly, the next broken clock path of delay 200 nanosecond could further be broken up into 2 paths of 100 nanoseconds at a clocked rate of 1600 MHz. Now final broken path is 194 nanoseconds which could further be broken down into 100+94 nanosecond at a clocked rate of 1600 MHz. The delay of the broken critical path is dependent on the placement of D flip-flop between the two original flops. The final path of 100 nanosecond clock is clocked at the fastest clock and there is no possibility of further reduction of depth of the critical path. So, by using the present invention, the speed up of 394/100 is achieved which is roughly 4× gain. Furthermore, the said methodology is applicable to all multi-clock designs provided the ratio of fastest to slowest clock frequencies is at least greater than 2.

The present invention method is easily scalable and the concept can be extended to 2. 3. 4 . . . N different clocks or domains. The invention provides a method to improve the compile frequency (F_{Max}) for complex design by introducing the pipeline flops to reduce the delay of the critical path in the design. Also since the run time is reduced, it also helps in optimal usage of emulator up time and hence hardware area is used in an optimal manner.

The present method works for multiple frequency designs. It does not cause any functionality change and can be used in any verification environment with a synthesizable DUT (design under test). The present method also helps in reducing the verification time, which in turn helps to reduce time to market for VLSI designs.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

I claim:

1) A method for improving the compile time synthesis frequency of a design on FPGA or emulation system, wherein the method comprising:
synthesizing multi clock system on chip (SoC) design on FPGA or Emulation system and obtaining the compile or synthesis frequency (F_{Max});
analyzing the critical path in the design and recording the clock frequency corresponding to critical path;
breaking the critical path by inserting a pipeline flop clocked at faster clock rate, if the recorded clock frequency (rate) is not the fastest clock of the design; and
inserting the pipeline flop iteratively in the design whenever next longer critical path is encountered.

2) The method as claimed in claim 1, wherein the clock rate of the inserted pipeline flop is at least two times faster than the clock rate on critical path.

3) The method as claimed in claim 1, wherein the ratio of fastest to slowest clock is more than or equal to 2.

4) The method as claimed in claim 1 is applicable where the clocks of SOC design are synchronous to each other.
